(19) United States
(12) Patent Application Publication
(10) Pub. No.: US 2007/0128349 A1
(43) Pub. Date: Jun. 7, 2007

(54) Process for preparing ink-jet recording material

(76) Inventor: Norimasa Miyachi, Tokyo (JP)

Correspondence Address: BIRCH STEWART KOLASCH & BIRCH, PO BOX 747, FALLS CHURCH, VA, 22040-0747, US

(21) Appl. No.: 10/588,382

(22) PCT Filed: Dec. 21, 2004
(86) PCT No.: PCT/JP04/19089

§ 371 Date: Aug. 2, 2006

(30) Foreign Application Priority Data
Feb. 3, 2004 (JP) 2004-027057

(51) Int. Cl. B41M 3/12

(52) U.S. Cl. 427/152

(57) ABSTRACT

The present invention discloses a process for preparing an ink-jet recording material which comprises an ink-receptive layer (A) containing fine inorganic particles having an average secondary particle size of 500 nm or less and a resin binder having a keto group on a support, and on the above-mentioned support, (1) a coating solution (B) containing a cross-linking agent of the above-mentioned resin binder having a keto group is previously coated, and then, a coating solution of the above-mentioned ink-receptive layer (A) is coated on the coated film of the above-mentioned coating solution (B), or (2) a coating solution containing a boron compound in addition to the coating solution of the above-mentioned ink-receptive layer (A) is coated, and then, on the coated film of the above-mentioned coating solution, the coating solution (B) containing a cross-linking agent of the resin binder containing the above keto group is coated.

### TECHNICAL FIELD

The present invention relates to a process for preparing an ink-jet recording material, more specifically to a process for preparing an ink-jet recording material which can prepare the same by preventing occurrence of coating defects such as cracks or a dryer air pattern on a coating, etc. of the ink-receptive layer, which become serious problems when a void type ink-receptive layer containing ultrafine inorganic particles is coated on a support, and further can prepare with good production efficiency, to realize photo-like high glossiness and high ink-absorption ability.

### BACKGROUND ART

As a recording material to be used for an ink-jet recording system, a recording material which comprises an ink-receptive layer being provided on a support such as paper or plastic resin film, etc. has been known. The ink-receptive layer can be roughly classified into two types. One of which is an ink-receptive layer mainly comprising a water-soluble polymer, and the other is an ink-receptive layer mainly comprising an inorganic pigment and a resin binder.

In the former type of the ink-receptive layer, ink is absorbed by the water-soluble polymer that is swelling. In the latter type of the ink-receptive layer, ink is absorbed in voids formed by the inorganic pigments. Due to such a difference in mechanism of absorbing ink, the former type is called to as a swelling type (or a polymer type) and the latter is a void type.

In the former type of the ink-receptive layer, glossiness is excellent since it forms a continuous uniform film but ink-absorption ability (an ink-absorption rate; a drying rate after printing) is poor. On the other hand, in the latter void type, ink-absorption ability is excellent but glossiness is poor.

However, in the above-mentioned conventionally known recording material, in addition to the points of quality such as high glossiness, high ink-absorption ability, no formation of cracks or cracks by folding, they are not yet satisfied sufficiently in the point of improvement in productivity.

In recent years, a recording material excellent in both of the ink-absorption ability and glossiness has been earnestly desired, and a void type recording material using ultrafine inorganic particles as a pigment has been proposed. For example, it has been proposed to use ultrafine inorganic particles such as a fumed silica (a gas phase process silica) or a wet process silica, etc., pulverized and dispersed to have an average secondary particle size of 500 nm or less as a pigment component for an ink-receptive layer. For example, in Japanese Patent Publication No. Hei. 3-56552, Japanese Laid-Open Patent Publications No. Hei. 10-119423, No. 2000-211235 and No. 2000-309157, there have been disclosed to use fumed silica, in Japanese Laid-Open Patent Publications No. Hei. 9-286165 and No. Hei. 10-181190, there have been disclosed to use pulverized silica prepared by a precipitation process, and in Japanese Laid-Open Patent Publication No. 2001-277712, there has been disclosed to use pulverized silica prepared by a gel process. Moreover, in Japanese Laid-Open Patent Publications No. Sho. 62-174183, No. Hei. 2-276670, No. Hei. 5-32037 and No. Hei. 6-199034, there have been disclosed recording materials using alumina or alumina hydrate.

However, when ultrafine inorganic particles as mentioned above are used, high glossiness can be obtained but to the contrary, surface defects such as a dryer air pattern (drying unevenness) or cracks, etc. likely caused at the time of coating and drying. In particular, polyolefin resin-coated paper (those in which a polyolefin resin such as polyethylene, etc. is laminated on both surfaces of paper) or a non-water-absorptive support such as polyester film, etc., is used to obtain high glossiness or good feelings, the support cannot absorb ink, so that an ink absorption ability of the ink-receptive layer provided on a support is important. Accordingly, to heighten void ratio and void volume of an ink-receptive layer, the ink-receptive layer is required to be constituted by a large amount of a pigment and a low ratio of a binder, and as a result, at the time of coating and drying the ink-receptive layer, dryer air patterns and cracks are easily generated more and more. Also, in addition to the surface defects at the time of the preparation as mentioned above, cracks by folding (a phenomenon in which cracks occur at the folded portion) which occur at the time of handling the recording material are also a problem.

Also, when coated paper or cast-coated paper is used as a support, the above-mentioned cracks are likely generated as compared with the general paper support.

To prevent such surface defects, it has been known a method in which a coating solution of an ink-receptive layer containing a cross-linking agent is coated on a support, and then, drying process is carried out under relatively mild conditions. For example, in Japanese Laid-Open Patent Publications No. Hei. 10-119423, No. 2000-27093, No. 2001-96900, etc., there are disclosed a method in which a boron compound such as boric acid, borate, borax, etc., is used as a cross-linking agent of polyvinyl alcohol, a coating solution is coated and then once cooled to increase a viscosity of the coated solution, and drying process is carried out at a relatively low temperature. Also, it has been known, as a cross-linking agent, an aldehyde type compound, an epoxy compound, or an isocyanate, etc. However, such prior art techniques are limited in coating and drying conditions, and as a result, lowering in productivity is caused. Further, slight change in drying temperature causes remarkable surface defects in some cases.

On the other hand, it has been known an ink-jet recording material containing an acetoacetyl group-modified polyvinyl alcohol and its cross-linking agent. For example, it has been disclosed in Patent Literatures 1 to 7, etc.

However, in the above-mentioned prior art techniques, an acetoacetyl group-modified polyvinyl alcohol and its cross-linking agent are contained in the same coating solution, so that agglomerate is likely generated and coating is carried out continuously, agglomerates are attached to a coating device whereby there is a problem that coating stability is poor. This is a problem caused by high reactivity between the acetoacetyl group-modified polyvinyl alcohol and its cross-linking agent. A flow rate of a coating solution near to the wall surface of the coating device is extremely slow, so that an aggregate due to cross-linking reaction generates at the portion, and said aggregate becomes a core of a further aggregate and a larger sized aggregate grows. As a result, a coating width becomes narrower since contraction flow to the inside is caused, and coating defects occur on the coated surface such as a line or fish-eyes.

In Patent Literature 8, there is disclosed a method of coating a coating solution containing a cross-linking agent after providing an ink-receptive layer containing an acetoacetyl group-modified polyvinyl alcohol by coating. This method requires to carry out coating of the coating solution containing a cross-linking agent at the time of the ink-receptive layer coated on the support being a wet state (not dried state). Accordingly, the condition of the ink-receptive layer when a coating solution containing a cross-linking agent is coated affects to the coating property. That is, if the coating solution containing a cross-linking agent is coated when the viscosity of the coated ink-receptive layer is not so increased, coating defects such as a line or fish-eyes, etc., likely occur. To the contrary, when drying is carried out until the concentration of solid components of the coated ink-receptive layer becomes sufficiently high, then the drying time is long whereby productivity becomes low. In particular, when a non-water-absorptive support is used, the above-mentioned problems are likely caused. Accordingly, in this method, coating stability and productivity could not be satisfied simultaneously.
[Patent Literature 1] Japanese Laid-Open Patent Publication No. Sho. 63-176173
[Patent Literature 2] Japanese Laid-Open Patent Publication No. Hei. 10-157283
[Patent Literature 3] Japanese Laid-Open Patent Publication No. 2000-52646
[Patent Literature 4] Japanese Patent Publication No. Hei. 4-15746
[Patent Literature 5] Japanese Laid-Open Patent Publication No. 2000-280600
[Patent Literature 6] Japanese Laid-Open Patent Publication No. 2001-72711
[Patent Literature 7] Japanese Laid-Open Patent Publication No. 2001-213045
[Patent Literature 8] Japanese Laid-Open Patent Publication No. 2003-335043

### DISCLOSURE OF THE INVENTION

[Problems to be Solved by the Invention]

The objects of the present invention are to realize both of photo-like high-glossiness and high ink-absorption ability, and to prevent occurrence of coating defects such as cracks or a dryer air pattern of the ink-receptive layer which become serious problems when a void type ink-receptive layer containing ultrafine inorganic particles is coated on a support, and further to provide a process for preparing an ink-jet recording material which can be carried out with good production efficiency. The present invention is further to improve water resistance and resistance to cracks by folding of the ink-receptive layer.

[Means to Solve the Problems]

The above-mentioned objects of the present invention can be basically accomplished by the following inventions.

(1) A process for preparing an ink-jet recording material which comprises an ink-receptive layer (A) containing fine inorganic particles having an average secondary particle size of 500 nm or less and a resin binder having a keto group on a support, wherein a coating solution (B) containing a cross-linking agent of the resin binder having a keto group is previously coated onto the above support, and then a coating solution of the above-mentioned ink-receptive layer (A) is coated on the coating solution (B).

(2) A process for preparing ink-jet recording material which comprises an ink-receptive layer (A) containing fine inorganic particles having an average secondary particle size of 500 nm or less and a resin binder having a keto group on a support, wherein a coating solution containing a boron compound in addition to the coating solution of the above-mentioned ink-receptive layer (A) on the above-mentioned support, and then the coating solution (B) containing a cross-linking agent of the resin binder containing the above keto group is coated on a coated film of the above-mentioned coating solution.

[Effects of the Invention]

According to the preparation process of the present invention, in order to realize photo-like high glossiness and high ink-absorption ability, occurrence of coating defects such as cracks or a dryer air pattern, etc., of the ink-receptive layer can be effectively prevented, which become serious problems when a void type ink-receptive layer containing ultrafine inorganic particles is coated on a support, and production can be carried out with good efficiency. Moreover, according to the present invention, water resistance and resistance to cracks by folding of the ink-receptive layer can be improved.

[Best Mode for Carrying out the Invention]

As the fine inorganic particles to be used in the ink-receptive layer of the present invention, there may be mentioned conventionally known various kinds of fine particles such as amorphous synthetic silica, alumina, alumina hydrate, calcium carbonate, magnesium carbonate, titanium dioxide, etc., and amorphous synthetic silica, alumina or alumina hydrate is preferred in the points of ink-absorption ability and productivity. The ink-receptive layer of the present invention is a void type mainly containing fine inorganic particles, and a ratio of the fine inorganic particles to be contained is 50% by weight or more based on the total solid content of the ink-receptive layer, preferably in the range of 60 to 95% by weight.

The amorphous synthetic silica can be roughly classified into wet process silica, fumed silica, and others. The wet process silica can be further classified into a precipitation method silica, a gel method silica, and a sol method silica according to the preparation processes. The precipitation method silica can be prepared by reacting sodium silicate and sulfuric acid under alkali conditions, silica particles grown in particle size aggregated and precipitated, and then, they are processed through filtration, washing, drying, pulverization and classification to prepare a product. As the precipitation method silica, it is commercially available, for example, as Nipsil from SILICA CORPORATION, and as Tokusil from K.K. Tokuyama. The gel method silica can be produced by reacting sodium silicate and sulfuric acid under acidic conditions. In this method, small particles are dissolved during ripening and reprecipitated occurs in which primary particles are combined to each other. Thus, clear primary particles disappear and relatively hard agglomerated particles having internal void structure are formed. It is commercially available, for example, as Nipgil from SILICA CORPORATION, and as Syloid or Sylojet from Grace Japan Co., Ltd. The sol method silica is also called to as colloidal silica and can be obtained by heating and ripening silica sol obtained by metathesis of sodium silicate by using an acid, etc., or passing through an ion-exchange resin layer, and is commercially available, for example, as SNOWTEX from Nissan Chemical Industries, Ltd.

The fumed silica is also called to as the dry process silica contrary with the wet process silica, and it can be generally prepared by a flame hydrolysis method. More specifically, it has generally been known a method in which silicon tetrachloride is burned with hydrogen and oxygen, and silanes such as methyltrichlorosilane, trichlorosilane, etc., may be used in place of silicon tetrachloride, singly or in admixture with the silicon tetrachloride. The fumed silica is commercially available as Aerosil from Nippon Aerosil K.K., and as QS type from K.K. Tokuyama.

In the present invention, fumed silica is particularly preferably used. An average primary particle size of the fumed silica to be used in the present invention is preferably 30 nm or less, and more preferably 15 nm or less to obtain higher glossiness. More preferred are to use those having an average primary particle size of 3 to 15 nm (particularly 3 to 10 nm), and having a specific surface area measured by the BET method of 200 m²/g or more (preferably 250 to 500 m²/g). Incidentally, the average primary particle size referred to in the present invention means an average particle size of fine particles using 100 primary particles existing in a predetermined surface area and diameters of the circles thereof equivalent to the projected surface area of the respective primary particles according to electron microscopic observation as a particle diameter, and the BET method mentioned in the present invention means one of methods for measuring a surface area of powder material by a gas phase adsorption method and is a method for obtaining a total surface area possessed by 1 g of a sample, i.e., a specific surface area, from an adsorption isotherm. In general, as an adsorption gas, nitrogen gas has frequently been used, and a method of measuring an adsorption amount obtained by the change in pressure or a volume of a gas to be adsorbed has most frequently been used. Most famous equation for representing isotherm of polymolecular adsorption is a Brunauer-Emmett-Teller equation which is also called to as a BET equation and has widely been used for determining a surface area of a substance to be examined. A surface area can be obtained by measuring an adsorption amount based on the BET equation and multiplying the amount with a surface area occupied by the surface of one adsorbed molecule.

In the ink-receptive layer of the present invention, a fumed silica is preferably used by dispersing the fumed silica to have an average secondary particle size of 500 nm or less, preferably 10 to 300 nm, further preferably 20 to 200 nm in the presence of a cationic compound. As a dispersing method, the fumed silica and a dispersing medium are provisionally mixed with general propeller stirring, turbine type stirring, homomixer type stirring, etc., then, dispersing treatment is preferably carried out by using a media mill such as a ball mill, a beads mill, a sand grinder, etc., a pressure type dispersing machine such as a high pressure homogenizer, a ultra-high pressure homogenizer, etc., a ultrasonic wave dispersing machine, and a thin film spin system disperser, etc. Incidentally, an average secondary particle size referred to in the present invention means an average value of the dispersed aggregated particles which can be observed by the ink-receptive layer of the resulting recording material using an electron microscope.

In the present invention, wet process silica in which it is pulverized to have an average secondary particle size of 500 nm or less may be preferably used. As the wet process silica to be used in the present invention, wet process silica having an average primary particle size of 50 nm or less, preferably 3 to 40 nm, and an average agglomerated particle size of 5 to 50 μm is preferred, and it is preferred to use the above wet process silica by finely pulverizing them by an average secondary particle size of 500 nm or less, preferably 20 to 200 nm or so in the presence of a cationic compound.

The wet process silica prepared by the general method has an average aggregated particle size of 1 μm or more, so that it is used by subjecting to fine pulverization. As the pulverization method, a wet dispersing method in which silica dispersed in an aqueous medium is mechanically pulverized can be preferably used. At this time, increase in initial viscosity of the dispersion can be controlled, dispersion with a high concentration can be realized and a pulverization and dispersion efficiency can be realized so that the particles can be pulverized finer, so that precipitation method silica having an oil absorption amount of 210 ml/100 g or less, and an average agglomerated particle size of 5 μm or more is preferably used. By using a dispersion with a high concentration, productivity of the printing paper is improved. The oil absorption amount can be measured based on the description of JIS K-5101.

As a specific method for obtaining wet process silica having an average secondary particle size of 500 nm or less in the present invention, first, a provisional dispersion in which silica particles and a cationic compound are mixed is prepared. In the provisional dispersion, silica particles and the cationic compound are mixed and dispersed by using at least one of a saw blade type dispersing device, a propeller blade type dispersing device, and a rotor stator type dispersing device. If necessary, a suitable amount of a low boiling point solvent, etc., may be further added to the dispersion. A solid concentration of the silica provisional dispersion is preferably as high as possible, but if it is too high concentration, dispersion becomes impossible, so that the solid concentration is preferably in the range of 15 to 40% by weight, more preferably 20 to 35% by weight. Next, a wet process silica dispersion having an average secondary particle size of 500 nm or less can be obtained by applying thereto to a more potent mechanical means. As the mechanical means, those conventionally known in the art can be employed, and there may be used, for example, a media mill such as a ball mill, a beads mill, a sand grinder, etc., a pressure type dispersing device such as a high-pressure homogenizer, an ultra high-pressure homogenizer, etc., an ultrasonic wave dispersing device, and a thin-film spin type dispersing device, etc.

As the cationic compound to be used for dispersion of the above-mentioned fumed silica and wet process silica, a cationic polymer can be preferably used. As the cationic polymer, preferably used are polyethyleneimine, polydiallylamine, polyallylamine, alkylamine polymer, as well as polymers having a primary to tertiary amino group or a quaternary ammonium group as disclosed in Japanese Laid-Open Patent Publication No. Sho. 59-20696, No. Sho. 59-33176, No. Sho. 59-33177, No. Sho. 59-155088, No. Sho. 60-11389, No. Sho. 60-49990, No. Sho. 60-83882, No. Sho. 60-109894, No. Sho. 62-198493, No. Sho. 63-49478, No. Sho. 63-115780, No. Sho. 63-280681, No. Hei. 1-40371, No. Hei. 6-234268, No. Hei. 7-125411, No. Hei. 10-193776, etc. In particular, a diallylamine derivative is preferably used as the cationic polymer. A molecular weight of these cationic polymers is preferably 2,000 to 100,000 or so, particularly preferably 2,000 to 30,000 or so in view of dispersibility and a viscosity of the dispersion. An amount of the cationic polymer to be added is preferably in the range of 1 to 10% by weight based on the amount of the silica.

As the alumina to be used in the present invention, γ-alumina which is a γ type crystal of aluminum oxide is preferred, and of these, δ group crystal is preferred. The γ-alumina can be made fine with a primary particle size of 10 nm or so, and generally those pulverized to have an average secondary particle size of 500 nm or less, preferably 20 to 300 nm of so may be used by pulverizing secondary particle crystals having several thousands to several ten thousands nm with an ultrasonic wave, a high pressure homogenizer or a counter-collision type jet pulverizer, etc.

The alumina hydrate of the present invention can be shown by the structural formula of Al₂O₃·nH₂O (n=1 to 3). When n is 1, it represents alumina hydrate with boehmite structure, and when n is larger than 1 and less than 3, it represents a pseudo boehmite structure alumina hydrate. It can be obtained by hydrolysis of aluminum alkoxide such as aluminum isopropoxide, etc., neutralization of aluminum salt with an alkali, hydrolysis of aluminate, etc. An average secondary particle size of alumina hydrate to be used in the present invention is 500 nm or less, preferably 20 to 300 nm.

The above-mentioned alumina, and alumina hydrate to be used in the present invention can be used in the formation of a dispersion in which it is dispersed by a conventionally known dispersant such as acetic acid, lactic acid, formic acid, nitric acid, etc.

The ink-receptive layer of the present invention contains a resin having a keto group as a binder of the fine inorganic particles. The resin binder having a keto group can be synthesized by copolymerizing a monomer having a keto group and other monomers. Specific examples of the monomer having keto group may be mentioned acrolein, diacetone acrylamide, diacetone methacrylate, acetoacetoxy ethylmethacrylate, 4-vinyl acetoacetoanilide, acetoacetylallylamide, etc. Also, a keto group may be introduced by the polymerization reaction, and for example, an acetoacetyl group can be introduced by the reaction of a hydroxy group and a diketone, etc. Specific examples of the resin binder having a keto group may be mentioned, acetoacetyl-modified polyvinyl alcohol, acetoacetyl-modified cellulose derivative, acetoacetyl-modified starch, diacetoneacrylamide-modified polyvinyl alcohol, a resin binder as disclosed in Japanese Laid-Open Patent Publication No. Hei. 10-157283, etc. In the present invention, modified polyvinyl alcohol having a keto group is particularly preferred. As the modified-polyvinyl alcohol having a keto group, there may be mentioned an acetoacetyl-modified polyvinyl alcohol, a diacetoneacrylamide-modified polyvinyl alcohol, etc.

The acetoacetyl-modified polyvinyl alcohol can be prepared by a conventionally known method such as a reaction of polyvinyl alcohol and diketene, etc. An acetoacetylation degree thereof is preferably 0.1 to 20 mol %, more preferably 1 to 15 mol %. A saponification degree thereof is preferably 80 mol % or more, more preferably 85 mol % or more. A polymerization degree thereof is preferably 500 to 5000, particularly preferably 2000 to 4500.

The diacetone acrylamide-modified polyvinyl alcohol can be prepared by a conventionally known method such as saponification of a diacetone acrylamide-vinyl acetate copolymer, etc. A content of the diacetone acrylamide unit is preferably in the range of 0.1 to 15 mol %, more preferably 0.5 to 10 mol %. A saponification degree thereof is preferably 85 mol % or more, and a polymerization degree thereof is preferably 500 to 5000.

In the present invention, in addition to the resin binder having a keto group, other conventionally known resin binder(s) may be used in combination. For example, cellulose derivative(s) such as carboxymethyl cellulose, hydroxypropyl cellulose, etc.; starch or various kinds of modified starches; gelatin or various kinds of modified gelatins; chitosan, carrageenan, casein, soybean protein, polyvinyl alcohol or various kinds of modified polyvinyl alcohols, polyvinyl pyrrolidone, polyacrylamide, etc. may be used in combination, if necessary. Moreover, various kinds of latexes may be used in combination as a resin binder.

At this time, in the point of glossiness, a resin binder having high compatibility with the resin binder having a keto group is preferably used in combination. When the modified polyvinyl alcohol having a keto group is used, a completely or partially-saponified polyvinyl alcohol or cationically-modified polyvinyl alcohol is preferably used in combination. In particular, polyvinyl alcohol having a saponification degree of 80% or more and an average polymerization degree of 200 to 5000 is preferably used.

The cationically-modified polyvinyl alcohol is a polyvinyl alcohol having a primary to tertiary amino group or a quaternary ammonium group at the main chain or side chain of the polyvinyl alcohol as disclosed in, for example, Japanese Unexamined Patent Publication No. Sho. 61-10483.

When the other resin binder is used in combination, an amount of the other resin binder to be used is preferably 50% by weight or less based on the amount of the resin binder having a keto group.

When a total content of the resin binder is a little, it is preferred in the point that a void volume in the ink-receptive layer is large so that an ink-absorption ability becomes high, but it is too little, the ink-receptive layer becomes brittle and surface defects such as cracks, etc., become remarkable or glossiness is lowered, so that it is preferably in the range of 5 to 40% by weight based on the amount of the fine inorganic particles, particularly preferably 10 to 30% by weight.

Next, a cross-linking agent of the resin binder having a keto group is explained. Such a cross-linking agent may be mentioned the following compounds.

(1) A Compound Containing Two or More Primary Amino Groups in the Molecule;

Here, the primary amino group means a primary amino group bonded to a carbon atom of an aliphatic group, an aromatic group, a heterocyclic group, and a primary amino group bonded to a nitrogen atom (that is, the terminal amino group of the hydrazine). In the point of thickening effect after mixing, a hydrazine type amino group is preferred, and in particular, those having a hydrazide, semicarbazide, or carbohydrazide structure are preferred. Specific examples of the compound having two or more primary amino groups bonded to carbon atoms, there may be mentioned ethylene diamine, diethylene triamine, triethylene diamine, metaxylylene diamine, norbornane diamine, 1,3-bisaminomethylcyclohexane, etc., and specific examples of the compound having two or more hydrazine type amino groups, there may be mentioned hydrazine and a salt thereof, carbohydrazide, a polycarboxylic acid hydrazide such as succinic acid dihydrazide, adipic acid dihydrazide, citric acid trihydrazide, sebacic acid dihydrazide, isophthalic acid dihydrazide, etc., a reaction product of polyisocyanate and hydrazine such as 4,4′-ethylenedisemicarbazide, 4,4′-hexamethylenedisemicarbazide, etc., a polymer type hydrazide such as polyacrylic acid hydrazide, etc. In particular, in the points of water-solubility and reactivity, succinic acid dihydrazide, adipic acid dihydrazide is/are preferred.

(2) Polyvalent Metal Salt;

There may be mentioned zirconium salt (zirconium nitrate, basic zirconium carbonate, zirconium acetate, zirconium sulfate, zirconium oxychloride, zirconium chloride, zirconium hydroxychloride, zirconium carbonate, ammonium zirconium carbonate, potassium zirconium carbonate, zirconium fluoride, etc.), titanium salt (titanium tetrachloride, titanium lactate, titanium tetraisopropyl titanate, etc.), aluminum salt (aluminum chloride, aluminum sulfate, aluminum lactate, etc.), calcium salt (calcium chloride, calcium sulfate, calcium acetate, calcium propionate, etc.), magnesium salt (magnesium chloride, magnesium sulfate, etc.), zinc salt (zinc chloride, zinc sulfate, zinc acetate, etc.) and the like. It is preferably zirconium salt.

(3) Aldehydes;

There may be mentioned a monoaldehyde including formaldehyde, acetaldehyde, propionaldehyde, butylaldehyde, chrotonaldehyde, benzaldehyde, etc., a dialdehyde including glyoxal, malon dialdehyde, succine dialdehyde, glutar dialdehyde, maleic dialdehyde, 1,8-octanedial, phthalaldehyde, isophthalaldehyde, terephthalaldehyde, both-ends aldehyde-added PVA (aldehyde-modified polyvinyl alcohol), etc., a copolymer having an aldehyde at the side chain obtained by saponificating arylidene vinyl acetate-diacetate copolymer, dialdehyde starch, polyacrolein, etc.

(4) Methylol Compounds;

There may be mentioned methylol phosphine, dimethylol urea, diethylol melamine, trimethylolmelamine, urea resin initial stage polymerized material, melamine resin initial stage polymerized material, etc.

(5) Activated Vinyl Compounds;

There may be mentioned a divinylsulfone series compound, β-hydroxyethyl sulfone series compounds, etc.

(6) Epoxy Compounds;

There may be mentioned epichlorohydrin, ethylene glycol diglycidyl ether, polyethylene glycol diglycidyl ether, glycerin di- or triglycidyl ether, 1,6-hexanediol diglycidyl ether, trimethylol propanetriglycidyl ether, diglycidyl aniline, diglycidyl amine, polyepoxy compound, etc.

(7) Isocyanate Series Compounds;

There may be mentioned tolylene diisocyanate, hydrogenated tolylene diisocyanate, trimethylol propane-tolylene diisocyanate adduct, triphenylmethane triisocyanate, methylenebis-4-phenylmethane triisocyanate, isophorone diisocyanate, and a ketoxime blocked product or a phenol blocked product of the above materials, polyisocyanate, etc.

(8) Phenol Series Compounds;

There may be mentioned a phenol series resin initial stage condensate, a resorcinol series resin, etc.

Among the above-mentioned cross-linking agents, (1) the compound having two or more primary amino groups in the molecule, and (2) the polyvalent metal salt are preferred, in particular, (1) the compound having two or more primary amino groups in the molecule is preferred.

A content of the cross-linking agent is preferably in the range of 0.1 to 50% by weight based on the amount of the resin binder having a keto group, particularly preferably in the range of 1 to 20% by weight.

One of the preparation methods of the present invention is to previously coat a coating solution (B) containing a cross-linking agent of the resin binder having a keto group on a support, before coating an ink-receptive layer (A) containing fine inorganic particles and the resin binder having a keto group. The timing of coating the ink-receptive layer (A) may be at any time either the coating solution (B) previously coated on the support is not yet in a dried state or a completely dried state.

When the support is a non-water-absorptive support such as a polyolefin resin-coated paper or a plastic resin film, a primer layer (which is also called as subbing layer) for strengthening adhesiveness between the support and the ink-receptive layer is provided in many cases. The coating solution (B) can be also acted as the primer layer. Also, the coating solution (B) may be coated on the primer layer.

When the support is a water-absorptive support such as coated paper or cast-coated paper, the coating solution (B) can have a function of a coat layer or a cast coat layer. Or else, the coating solution (B) may be coated on a coat layer or a cast coat layer.

The coating solution (B) may be a solution containing a cross-linking agent alone (a small amount of an organic solvent may be contained), and may be further contain a suitable surfactant or binder. When the coating solution (B) has a function of the above-mentioned primer layer, coat layer, or cast coat layer, it may be a layer in which a cross-linking agent alone is added to the components constituting said primer layer, coat layer, or cast coat layer.

As described above, when the non-water-absorptive support is to be used, the coating solution (B) can be also acted as a primer layer. That is, a cross-linking agent is contained in the coating solution of the primer layer. The primer layer comprises a binder as a main component. Such a binder may be mentioned a natural polymer compound such as gelatin, casein, etc., or a synthetic resin such as polyvinyl alcohol, polyvinylpyrrolidone, carboxymethyl cellulose, acrylic resin, polyester resin, vinylidene chloride, vinyl chloride resin, vinyl acetate resin, polystyrene, polyamide resin, polyurethane resin, etc. Preferred binder may include a water-soluble binder such as gelatin, casein, polyvinyl alcohol, polyvinylpyrrolidone, carboxymethyl cellulose, etc. A dried thickness of the primer layer is suitably 0.01 to 5 μm, preferably in the range of 0.01 to 2 μm, more preferably 0.02 to 1 μm.

In the present invention, when a water-absorptive support such as a coated paper or a cast-coated paper is used, it is preferred to coat a coating solution (B) containing a cross-linking agent on a coat layer or a cast coat layer. In this case, it is preferred to add a water-soluble binder such as polyvinyl alcohol in the coating solution (B) so that the cross-linking agent in the coating solution (B) does not permeate into the coat layer or paper. In particular, by using an acetoacetyl-modified polyvinyl alcohol or a diacetoneacrylamide-modified polyvinyl alcohol, permeation of the cross-linking agent into the coat layer or paper layer can be effectively controlled. In this case, by making an amount of the cross-linking agent to be added excessive to the functional group of the above-mentioned modified polyvinyl alcohol, and making a concentration of the solid components of the coating solution (B) about 5% by weight or less, progress of the reaction between the cross-linking agent and the above-mentioned modified polyvinyl alcohol in the coating solution can be controlled, and as a result, the coating solution can be maintained stably.

The primer layer, coat layer or cast coat layer is generally coated during the preparation steps of the support. When a coating solution (B) containing a cross-linking agent is to be coated on these layers, it may be carried out during the preparation steps of the support, or, may be continuously coated during the coating steps of the ink-receptive layer (A) with on-line. The latter is called to as tandem coating system. That is, in the present invention, a tandem coating system in which a coating solution (B) is firstly coated on the support, and an ink-receptive layer (A) is coated continuously on line, can be employed. In this case, the timing of coating the ink-receptive layer (A) may be either the time at which the coating solution (B) coated on the support is not yet dried, or at the time at which it is completely dried.

In the present invention, a coating solution (B) containing a cross-linking agent is previously coated on a support, and then, a coating solution of an ink-receptive layer (A) is coated. When the coating solution of an ink-receptive layer (A) is coated, the cross-linking agent previously coated on the support is dispersed in the ink-receptive layer, and reacts with the resin binder having a keto group in the ink-receptive layer. By reacting the resin binder having a keto group and its cross-linking agent in the ink-receptive layer, the ink-receptive layer is gelled. As a result, it is possible to carry out high temperature drying without causing cracks of the ink-receptive layer. The above-mentioned reaction becomes rapid at high temperature, so that it is preferred to heat the material at high temperature immediately after coating the coating solution of the ink-receptive layer (A). For example, the ink-receptive layer is once gelled by blowing air heated at 50° C. or higher, preferably 60° C. or higher for 1 second or longer, preferably 5 seconds or longer, thereafter a hot air of SOC or higher is blown to carry out drying whereby drying efficiency is improved.

Also, when a modified polyvinyl alcohol such as an acetoacetyl-modified polyvinyl alcohol is used as the resin binder having a keto group, and a boron compound is further used in combination, a method in which the material is once cooled after coating to be gelled and then dried at a high temperature may be employed. This method is inferior in a drying efficiency as compared to the above-mentioned method of gelling at a high temperature, but is significantly improved as compared to the conventional methods. Also, in this method, even when drying is carried out at a high temperature of 50° C. or higher, occurrence of cracks never happen.

In the present invention, a coating solution (B) containing a cross-linking agent is coated, then, a coating solution of an ink-receptive layer (A) is coated, and a coating solution (B′) containing a cross-linking agent may be further coated thereon. In this case, cross-linking agents contained in the coating solution (B) and the coating solution (B′) may be the same or different from each other.

In the other embodiment of the preparation method according to the present invention, a coating solution containing a boron compound in addition to the above-mentioned ink-receptive layer (A) is coated on a support, and then, the coating solution (B) containing a cross-linking agent of the resin binder containing the above keto group is coated thereon. In this method, the ink-receptive layer (A) and the coating solution (B) are coated by a tandem system. The coating solution (B) must be coated by the end of drying the ink-receptive layer (A) coated on the support. It is preferred that after coating the ink-receptive layer (A), the coating solution (B) is coated before entering into a falling-drying-rate period. In view of improvement in productivity, after coating the ink-receptive layer (A), the coating solution (B) is preferably coated within a short period of time.

In general, as for drying of the coating solution, drying is finished from a constant-drying-rate period to a falling-drying-rate period. The constant-drying-rate period is a step in which free water (or a solvent) in the coated layer is evaporated by its evaporation latent heat, and a surface temperature of the coated paper is substantially constant. Void structure, etc. of the ink-receptive layer is substantially formed in this step. The falling-drying-rate period is a step in which water or the solvent adsorbed with the fine inorganic particles or the hydrophilic binder in the coated layer by interaction is evaporated, and an energy to disentangle these interactions is required in addition to the evaporation latent heat. In this falling-drying-rate period, a surface temperature of the coated paper is gradually raised. The temperature at which the surface temperature of the coated paper and the temperature in the dryer coincide is a terminal point of the drying.

As mentioned above, the timing of coating the coating solution (B) is preferably before entering the ink-receptive layer (A) coated on the support into the falling-drying-rate period. Moreover, preferred is that after coating the coating solution of the ink-receptive layer (A), it is once cooled to thicken the coated solution, the coating solution (B) is coated within a short period of time (for example, within 20 seconds).

A viscosity of the coating solution of the ink-receptive layer is increased at a low temperature by further adding a boron compound to the ink-receptive layer (A). Coating of the coating solution (B) can be carried out stably by cooling the ink-receptive layer (A) coated on the support to 25° C. or lower, preferably 15° C. or lower to thicken the same. Also, a high temperature drying at 50° C. or higher can be realized without causing cracks by coating the coating solution (B) while the ink-receptive layer (A) is in an undried state. According to the above, productivity can be improved without causing coating defects as compared with the conventional preparation methods. For coating the coating solution (B), a previously quantitating system such as a curtain coating system, and a coating system which does not contact with the support is preferably used.

As the boron compound to be used in the present invention, it is preferably at least one compound selected from boric acid, borate and borax. The content of the boron compound is preferably in the range of 0.01 to 40% by weight, particularly preferably in the range of 0.5 to 40% by weight based on the amount of the resin binder having a keto group.

As the dry coated amount of the ink-receptive layer of the present invention, it is generally in the range of 8 to 40 g/m², particularly preferably in the range of 10 to 30 g/m² as a solid content of the fine inorganic particles in view of ink-absorption ability, strength of the ink-receptive layer, and productivity.

In the present invention, for the purpose of improvement in water resistance of ink dye, etc., it is preferred to further add a cationic compound to the ink-receptive layer. As the examples of the cationic compound, the cationic polymer mentioned at the explanation of dispersion of silica can be preferably used.

In the present invention, in addition to the above-mentioned ink-receptive layer, an ink absorption layer with the other constitution, or a layer having a different function such as a protective layer, etc., may be further provided.

In the present invention, to the ink-receptive layer and the other layers, various kinds of conventionally known additives such as a surfactant, a coloring dye, a coloring pigment, a fixing agent for an ink coloring agent, a UV ray absorber, an antioxidant, a dispersant of pigment, a defoaming agent, a leveling agent, an antiseptic agent, a fluorescent brightener, a viscosity stabilizer, a pH controller, etc., may be further added.

As the support to be used in the present invention, there may be used a plastic resin film such as a polyethylene, polypropylene, polyvinyl chloride, diacetate resin, triacetate resin, cellophane, acrylic resin, polyethylene terephthalate, polyethylene naphthalate, etc., a non-water-absorptive support such as a polyolefin resin-coated paper, etc., and a water-absorptive support such as uncoated paper, art paper, coated paper, cast-coated paper, etc. Preferred non-water-absorptive support is a polyolefin resin-coated paper, and preferred water-absorptive paper is a cast-coated paper. A thickness of these supports is preferably that having about 50 to 250 μm or so.

In particular, when a plastic resin film or a polyolefin resin-coated paper which is a non-water-absorptive support is used, the above-mentioned primer layer is preferably provided on the surface on which the ink-receptive layer is to be provided.

Onto the support of the present invention, various kinds of back coating layer(s) may be provided by coating for the purpose of providing writability, antistatic property, conveying property, anticurl property, etc. In the back coating layer, an inorganic antistatic agent, an organic antistatic agent, a hydrophilic binder, a latex, a pigment, a curing agent, a surfactant, etc. may be included in an optional combination.

When a coating solution of an ink-receptive layer is provided on a plastic resin film or a resin-coated paper, it is preferred to carry out a corona discharge treatment, flame treatment, UV ray irradiation treatment, plasma treatment, etc., prior to provision of the coating.

As the coating method to be used in the present invention, there may be mentioned, for example, a slide bead system, a curtain system, an extrusion system, an air knife system, a roll coating system, a rod bar coating system, a fountain system, a direct fountain system, etc.

In the following, the present invention is explained in more detail by referring to Examples, but the present invention is not limited by these Examples. Incidentally, all “part(s)” and “%” mean “part(s) by weight” and “% by weight” of a solid component, respectively.

### EXAMPLE 1

Examples in which a cross-linking agent of the resin binder having a keto group was contained in the primer layer on the non-water-absorptive support are shown below.

<<Preparation of Recording Sheet of the Present Invention 1>>

<Preparation of Polyolefin Resin-Coated Paper Support>

A mixture of a bleached kraft pulp of hardwood (LBKP) and a bleached sulfite pulp of softwood (NBSP) with a ratio of 1:1 was subjected to beating until it becomes 300 ml by the Canadian Standard Freeness to prepare a pulp slurry. To the slurry were added alkyl ketene dimer in an amount of 0.5% based on the amount of the pulp as a sizing agent, polyacrylamide in an amount of 1.0% based on the same as a strengthening additive of paper, cationic starch in an amount of 2.0% based on the same, and a polyamide epichlorohydrin resin in an amount of 0.5% based on the same, and the mixture was diluted with water to prepare a slurry with a concentration of 1%. This slurry was made paper by a tourdrinier paper machine to have a basis weight of 170 g/m², dried and subjected to moisture conditioning to prepare a base paper for a polyolefin resin-coated paper. A polyethylene resin composition comprising 100 parts of a low density polyethylene having a density of 0.918 g/cm³ and 10 parts of anatase type titanium and dispersed uniformly in the resin was melted at 320° C. and the melted resin composition was subjected to extrusion coating on a surface of the above-mentioned base paper with a thickness of 35 μm by 200 m/min and subjected to extrusion coating by using a cooling roller subjected to slightly roughening treatment to make a resin-coated paper front surface. On the other surface of the base paper, a blended resin composition comprising 70 parts of a high density polyethylene resin having a density of 0.962 g/cm³ and 30 parts of a low density polyethylene resin having a density of 0.918 g/cm³ was melted similarly at 320° C. and the melted resin composition was subjected to extrusion coating with a thickness of 30 μm and subjected to extrusion coating by using a cooling roller subjected to roughening treatment to make a resin-coated paper back surface.

Onto the front surface of the above-mentioned polyolefin resin-coated paper was subjected to a high frequency corona discharge treatment, and then, a primer layer having the composition mentioned below was coated thereon to have the gelatin amount of 50 mg/m² (about 0.05 μm) and dried to prepare a support. This primer layer had also a function of the coating solution (B) containing a cross-linking agent.

<Primer Layer>

| | |
|---|---|
| Lime-treated gelatin | 100 parts |
| 2-Ethylhexyl sulfosuccinate | 2 parts |
| Chromium alum | 10 parts |
| Adipic acid dihydrazide (cross-linking agent) | 912 parts |

<Preparation of Silica Dispersion 1>

To water were added 4 parts of dimethyldiallyl ammonium chloride homopolymer (Molecular weight: 9,000) and 100 parts of fumed silica (Average primary particle size of 7 nm, Specific surface area: 300 m²/g) to prepare a provisional dispersion, and it was treated by a high pressure homogenizer to prepare Silica dispersion 1 with a concentration of solid components of 20%.

<Ink-Receptive Layer Coating Solution>

| | | |
|---|---|---|
| Silica dispersion 1 (As a silica solid component) | 100 | parts |
| Acetoacetyl-modified polyvinyl alcohol (Acetoacetylation | 23 | parts |
| degree: 3%, Saponification degree: 98%, Average | | |
| polymerization degree: 2350) | | |
| Basic polyaluminum hydroxide | 3 | parts |
| Nonionic surfactant (Polyoxyethylene alkyl ether) | 0.4 | part |

Silica dispersion 1 and other chemicals dissolved in water were mixed at 40° C., to prepare an ink-receptive layer coating solution with a concentration of solid components of 14%.

This ink-receptive layer coating solution was coated on the above-mentioned support by a slide bead coating system so that the coated amount of the fine silica particles was 20 g/m². Immediately after coating the ink-receptive layer coating solution, it was heated at 80° C. for 15 seconds to let the coating solution galate, then blowing air of SOC, and of 70° C. were successively blown to dry the layer. <<Preparation of Recording Sheet of the Present Invention 2>>

In the same manner as in the recording sheet of the above-mentioned the present invention 1 except for changing the primer layer to the following composition, the recording sheet was prepared.

<Primer Layer>

| | |
|---|---|
| Lime-treated gelatin | 100 parts |
| 2-Ethylhexyl sulfosuccinate | 2 parts |
| Chromium alum | 10 parts |
| Adipic acid dihydrazide (cross-linking agent) | 183 parts |

<<Preparation of Recording Sheet of the Present Invention 3>>

In the same manner as in the recording sheet of the above-mentioned the present invention 1 except for changing the primer layer to the following composition, the recording sheet was prepared.

<Primer Layer>

| | |
|---|---|
| Lime-treated gelatin | 100 parts |
| 2-Ethylhexyl sulfosuccinate | 2 parts |
| Chromium alum | 10 parts |
| Succinic acid dihydrazide (cross-linking agent) | 912 parts |

<<Preparation of Recording Sheet of the Present Invention 4>>

In the same manner as in the recording sheet of the above-mentioned the present invention 1 except for changing the ink-receptive layer coating solution to the following composition, and drying is carried out by cooling at 0° C. for 15 seconds immediately after the coating, and successively blowing air of 50° C., and then of 70° C., the recording sheet was prepared.

<Ink-Receptive Layer Coating Solution>

| | | |
|---|---|---|
| Silica dispersion 1 (As a silica solid component) | 100 | parts |
| Acetoacetyl-modified polyvinyl alcohol (Acetoacetylation | 23 | parts |
| degree: 3%, Saponification degree: 98%, Average | | |
| polymerization degree: 2350) | | |
| Boric acid | 2 | parts |
| Basic polyaluminum hydroxide | 3 | parts |
| Nonionic surfactant (Polyoxyethylene alkyl ether) | 0.4 | part |

<<Preparation of Recording Sheet of the Present Invention 5>>

In the same manner as in the recording sheet of the above-mentioned the present invention 1 except for changing the ink-receptive layer coating solution to the following composition, the recording sheet was prepared.

<Ink-Receptive Layer Coating Solution>

| | | |
|---|---|---|
| Silica dispersion 1 (As a silica solid component) | 100 | parts |
| Acetoacetyl-modified polyvinyl alcohol (Acetoacetylation | 23 | parts |
| degree: 3%, Saponification degree: 98%, Average | | |
| polymerization degree: 1200) | | |
| Basic polyaluminum hydroxide | 3 | parts |
| Nonionic surfactant (Polyoxyethylene alkyl ether) | 0.4 | part |

<<Preparation of Recording Sheet of Comparative 1>>

In the same manner as in the recording sheet of the above-mentioned the present invention 1 except for changing the primer layer to the following composition, the recording sheet was prepared.

<Primer Layer>

| | |
|---|---|
| Lime-treated gelatin | 100 parts |
| 2-Ethylhexyl sulfosuccinate | 2 parts |
| Chromium alum | 10 parts |

<<Preparation of Recording Sheet of Comparative 2>>

In the same manner as in the recording sheet of the above-mentioned the present invention 1 except for changing the ink-receptive layer to the following composition, the recording sheet was prepared.

<Ink-Receptive Layer Coating Solution>

| | |
|---|---|
| Silica dispersion 1 (As a silica solid component) | 100 parts |
| Polyvinyl alcohol (Saponification degree: 88%, Average | 23 parts |
| polymerization degree: 3500) | |
| Boric acid | 5 parts |
| Basic polyaluminum hydroxide | 3 parts |

<<Preparation of Recording Sheet of Comparative 3>>

Recording sheet was prepared in the same manner as in the recording sheet of the above-mentioned present invention 1 except for changing the primer layer to the same primer layer composition used in Preparation of recording sheet of Comparative 1 and changing the ink-receptive layer to the following composition.

<Ink-Receptive Layer Coating Solution>

| | |
|---|---|
| Silica dispersion 1 (As a silica solid component) | 100 parts |
| Polyvinyl alcohol (Saponification degree: 88%, Average | 23 parts |
| polymerization degree: 3500) | |
| Boric acid | 5 parts |
| Basic polyaluminum hydroxide | 3 parts |

<<Preparation of Recording Sheet of Comparative 4>>

Recording sheet was prepared in the same manner as in the recording sheet of the above-mentioned present invention 1 except for changing the primer layer to the same primer layer composition used in Preparation of recording sheet of Comparative 1 and changing the ink-receptive layer to the following composition.

<Ink-Receptive Layer Coating Solution>

| | | |
|---|---|---|
| Silica dispersion 1 (As a silica solid component) | 100 | parts |
| Acetoacetyl-modified polyvinyl alcohol (Acetoacetylation | 23 | parts |
| degree: 3%, Saponification degree: 98%, Average | | |
| polymerization degree: 2350) | | |
| Basic polyaluminum hydroxide | 3 | parts |
| Adipic acid dihydrazide (cross-linking agent) | 2.3 | parts |

<<Preparation of Recording Sheet of Comparative 5>>

Recording sheet was prepared in the same manner as in the recording sheet of the above-mentioned present invention 1 except for changing the primer layer to the same primer layer composition used in Preparation of recording sheet of Comparative 1 and changing the ink-receptive layer to the following composition. Provided that immediately after coating the ink-receptive layer coating solution, it was cooled at 0° C. for 15 seconds to thicken the coating solution, and then, dried by blowing air at 40° C.

<Ink-Receptive Layer Coating Solution>

| | |
|---|---|
| Silica dispersion 1 (As a silica solid component) | 100 parts |
| Polyvinyl alcohol (Saponification degree: 88%, Average | 23 parts |
| polymerization degree: 3500) | |
| Boric acid | 5 parts |
| Basic polyaluminum hydroxide | 3 parts |

<<Preparation of Recording Sheet of Comparative 6>>

In the same manner as in the recording sheet of the above-mentioned the present invention 1 except for changing the primer layer to the following composition, the recording sheet was prepared.

<Primer Layer>

| | |
|---|---|
| Lime-treated gelatin | 100 parts |
| 2-Ethylhexyl sulfosuccinate | 2 parts |
| Chromium alum | 10 parts |
| Propionic acid hydrazide | 912 parts |

<<Preparation of Recording Sheet of Comparative 7>>

In the same manner as in the recording sheet of the above-mentioned the present invention 1 except for changing the ink-receptive layer to the following composition, the recording sheet was prepared.

<Ink-Receptive Layer Coating Solution>

| | | |
|---|---|---|
| The following Silica dispersion 2 (As a silica solid | 100 | parts |
| component) | | |
| Acetoacetyl-modified polyvinyl alcohol (Acetoacetylation | 23 | parts |
| degree: 3%, Saponification degree: 98%, Average | | |
| polymerization degree: 2350) | | |
| Basic polyaluminum hydroxide | 3 | parts |
| Nonionic surfactant (Polyoxyethylene alkyl ether) | 0.4 | part |

<Preparation of Silica Dispersion 2>

To water were added 4 parts of dimethyldiallyl ammonium chloride homopolymer (Molecular weight: 9,000) and 100 parts of fumed silica (average primary particle size of 7 nm, Specific surface area: 300 m²/g), whereby a provisional dispersion was prepared. Provided that secondary dispersion with a high pressure homogenizer was not carried out. Silica dispersion 2 having a concentration of the solid components of 20% was prepared.

With regard to the obtained respective ink-jet recording sheets, the following evaluations were carried out. The results are shown in Table 1. Incidentally, an average secondary particle size of the fine silica particle in the ink-receptive layer was each 80 nm, so long as Silica dispersion 1 was used. That of Comparative 7 using Silica dispersion 2 was 2.4 μm.

<Evaluation of Cracks>

The surface of the ink-receptive layer was observed, and evaluated according to the following criteria.
◯: Completely no crack, and uniform coated surface.
Δ: Small cracks which can hardly be judged with the naked eye occurred. ×: Large cracks which can be clearly judged with the naked eye occurred.
   <Glossiness at White Portion>

Glossiness at the white paper portion of the recording sheet before printing was observed with inclined light and evaluated by the following criteria.
◯: It possessed high glossy feeling as that of a color photography.
Δ: There was a little glossy feeling.
×: There was no glossy feeling.
   <Ink-Absorption Ability>

By using a commercially available ink-jet printer (manufactured by Seiko Epson K.K., PM-880C), solid printing with red, blue, green or black color was each carried out, and immediately after the printing, a PPC paper was put on the printed portion with a slight pressurization, and the degree of the amount of the ink transferred to the PPC paper was observed with the naked eye and evaluated by the following criteria.
◯: No transfer was observed.
Δ: Pale transfer was observed at the whole part of the printed portion.
×: Dark transfer was observed at the whole part of the printed portion.
   <Water Resistance of the Ink-Receptive Layer>

Water-drop was dropped on the surface of the recording sheet, and after allowing to stand for 1 minute, the surface was rubbed to observe the surface state. Incidentally, a recording sheet on the surface of which cracks were generated originally was not measured (it was shown as “-” in the table).
◯: No change.
Δ: Part of the ink-receptive layer was shaved, and it became a state with low glossiness.
×: Almost all the part of the ink-receptive layer was shaved state.
   <Property of Crack(s) by Folding>

When a recording sheet was wound on a cylinder having a diameter of 1 inch by making the printing surface up, whether cracks were observed at the surface with the naked eye or not. Incidentally, a recording sheet on the surface of which cracks were generated originally was not measured (it was shown as “-” in the table).
◯: No crack was observed.
×: Cracks were observed.
   <Coating Defects>

When 100 m² of a recording sheet was prepared, occurrence of partial defects of 3 mm or more and coating unevenness were observed with the naked eye, and evaluated by the following criteria. Incidentally, a recording sheet on the surface of which cracks were generated originally was not measured (it was shown as “-” in the table).
◯: Partial defect was 1 or less, and no coating unevenness occurred, or it was extremely minute level of less than 5% to the coating width direction.
Δ: Partial defects were in the range of 2 to 10, or coating unevenness was confirmed with a width of 5% or more and less than 20% to the coating width direction.

×: Partial defects were 11 or more, or coating unevenness was confirmed with a width of 20% or more to the coating width direction.

TABLE 1

| | | | Ink | | | |
|---|---|---|---|---|---|---|
| | | | absorp- | | Crack | |
| | | | tion | Water | by | |
| Recording | | Gloss- | abili- | resis- | fold- | Coating |
| sheet | Cracks | iness | ty | tance | ing | defects |
| Present | ◯ | ◯ | ◯ | ◯ | ◯ | ◯ |
| invention 1 | | | | | | |
| Present | ◯ | ◯ | ◯ | ◯ | ◯ | ◯ |
| invention 2 | | | | | | |
| Present | ◯ | ◯ | ◯ | ◯ | ◯ | ◯ |
| invention 3 | | | | | | |
| Present | ◯ | ◯ | ◯ | ◯ | ◯ | ◯ |
| invention 4 | | | | | | |
| Present | ◯ | ◯ | ◯ | ◯ | ◯ | ◯ |
| invention 5 | | | | | | |
| Comparative 1 | X | X | X | — | — | — |
| Comparative 2 | X | X | ◯ | — | — | — |
| Comparative 3 | X | X | ◯ | — | — | — |
| Comparative 4 | ◯ | ◯ | ◯ | ◯ | ◯ | X |
| Comparative 5 | ◯ | ◯ | ◯ | Δ | X | ◯ |
| Comparative 6 | X | X | X | — | — | — |
| Comparative 7 | ◯ | X | ◯ | ◯ | ◯ | Δ |

From the above-mentioned results, according to the preparation method of the present invention, it can be understood that an ink-jet recording material which causes no cracks nor cracks by folding, and excellent in glossiness, ink-absorption ability and water resistance can be obtained.

With regard to productivity, it was evaluated by the time from coating the ink-receptive layer coating solution to completion of drying. The recording sheet of Comparative 5 was used as a standard for evaluation. That is, Comparative 5 was prepared by the conventional and general preparation method containing a polyvinyl alcohol and boric acid in the ink-receptive layer, and to prevent occurrence of cracks, it was necessary to once cool after coating, and to dry the material at a relatively lower temperature of 40° C. or so. Thus, Comparative 5 was low in a drying efficiency. To the contrary, in the present invention, each of the recording sheets caused no occurrence of cracks even when they were dried at 50° C. or higher, and their drying efficiencies were markedly improved. In the present invention 4, after coating an ink-receptive layer coating solution, the sheet was once cooled so that its drying efficiency was slightly lowered as compared to the present invention 1, but its drying efficiency was significantly improved as compared to that of Comparative 5. Drying time of the present invention was 1/2 to 1/2.5 as compared with that of Comparative 5.

Also, Comparative 5 was insufficient in water resistance of the ink-receptive layer, and crack(s) by folding occurred in Comparative 5.

Comparative 3 employed the conventional method using a polyvinyl alcohol and boric acid, and drying was carried out at a high temperature of 50° C. or higher, but cracks occurred at the whole surface.

Comparative 4 was a sample in which fine inorganic particle, a resin binder having a keto group, and a cross-linking agent were contained in the same coating solution, and aggregated materials caused by cross-linking reaction attached to the coating device and coating defects occurred. Comparative 7 contains silica fine particle having an average secondary particle size of larger than 500 nm, so that glossiness was markedly lowered.

### EXAMPLE 2

Next, Examples wherein a coating solution (B) containing a cross-linking agent and an ink-receptive layer (A) were coated in a tandem system are shown below.

<<Preparation of Recording Sheet of the Present Invention 6>>

A high-frequency corona discharge treatment was applied onto the surface of the polyolefin resin-coated paper 1 of the present invention 1 of Example 1, and a primer layer with the same composition as that of the primer layer used in Preparation of recording sheet of Comparative 1 was coated and dried so that the gelatin amount became 50 mg/m² (about 0.05 μm) to prepare a support.

Onto the above-mentioned support, a coating solution containing the cross-linking agent with the following composition was coated so that the coated amount of adipic acid dihydrazide became 0.46 g/m² with a coating system using a fountain bar and an air knife, then, before drying said coating solution, an ink-receptive layer coating solution which was the present invention 1 of Example 1 was coated by a slide curtain system, and dried in the same manner.

<Coating Solution Containing Cross-Linking Agent>

| | | |
|---|---|---|
| Adipic acid dihydrazide (cross-linking agent) | 100 | parts |
| Betaine surfactant | 0.1 | part |

The concentration of the solid component was adjusted to be 3% with water
<<Preparation of Recording Sheet of the Present Invention 7>>

The recording sheet was prepared in the same manner as in the present invention 6 except that the ink-receptive layer coating solution was changed to the following composition, and after coating the ink-receptive layer coating solution, the sheet was immediately cooled to 0° C. for 15 seconds and then dried by blowing air of 50° C. and 70° C., successively.

<Ink-Receptive Layer Coating Solution>

| | | |
|---|---|---|
| Silica dispersion 1 (As a silica solid component) | 100 | parts |
| Acetoacetyl-modified polyvinyl alcohol (Acetoacetylation | 23 | parts |
| degree: 3%, Saponification degree: 98%, Average | | |
| polymerization degree: 2350) | | |
| Boric acid | 2 | parts |
| Basic polyaluminum hydroxide | 3 | parts |
| Nonionic surfactant (Polyoxyethylene alkyl ether) | 0.4 | part |

<<Preparation of Recording Sheet of the Present Invention 8>>

The recording sheet was prepared in the same manner as in the present invention 6 except for changing the coating solution to one containing a cross-linking agent with the following composition.

<Coating Solution Containing Cross-Linking Agent>

| | | |
|---|---|---|
| Adipic acid dihydrazide (cross-linking agent) | 100 | parts |
| Polyvinyl alcohol (Saponification degree: 80%, Average | 100 | parts |
| polymerization degree: 500) | | |
| Betaine surfactant | 0.1 | part |

The concentration of the solid component was adjusted to be 5% with water.

With regard to the resulting respective ink-jet recording sheets, evaluation was carried out in the same manner as in Example 1, excellent results as in Example 1 of the present invention in either of the characteristics. Also, even when drying was carried out at a high temperature of 50° C. or higher, occurrence of cracks did not occur and productivity was improved. Incidentally, the average secondary particle size of the fine silica particles was each 80 nm

### EXAMPLE 3

Next, Examples wherein a coating solution further containing a boron compound in addition to the composition of ink-receptive layer (A) was coated, and then, a coating solution (B) containing a cross-linking agent was coated with a tandem system are shown below.

<<Preparation of Recording Sheet of the Present Invention 9>>

A high-frequency corona discharge treatment was applied onto the surface of the polyolefin resin-coated paper of the present invention 1 of Example 1, and a primer layer with the same composition as that of the primer layer used in Preparation of recording sheet of Comparative 1 was coated and dried so that the gelatin amount became 50 mg/m² (about 0.05 μm) to prepare a support.

Onto the above-mentioned support, an ink-receptive layer coating solution with the following composition was coated so that the coated amount of fine silica particles became 20 g/m² with a slide bead system. Immediately after the coating, the support was cooled at 0° C. for 15 seconds to thicken the coated solution, and then, a coating solution containing a cross-linking agent with the following composition was coated so that the coated amount of adipic acid dihydrazide became 0.46 g/m² with a direct fountain system, and then, heated at 80° C. for 15 second and dried by blowing air of 50° C. and 70° C., successively.

<Ink-Receptive Layer Coating Solution>

| | |
|---|---|
| Silica dispersion 1 (As a silica solid component) | 100 parts |
| Acetoacetyl-modified polyvinyl alcohol (Acetoacetylation | 23 parts |
| degree: 3%, Saponification degree: 98%, Average | |
| polymerization degree: 2350) | |
| Boric acid | 2 parts |
| Basic polyaluminum hydroxide | 3 parts |

<Coating Solution Containing Cross-Linking Agent>

| | | |
|---|---|---|
| Adipic acid dihydrazide (cross-linking agent) | 100 | parts |
| Nonionic surfactant (Polyoxyethylene alkyl ether) | 0.1 | part |

The concentration of the solid component was adjusted to be 3% with water.
<Preparation of Recording Sheet of the Present Invention 10>>

The recording sheet was prepared in the same manner as in the present invention 9 except for changing the coated amount of the adipic acid dihydrazide to 0.1 g/m².

<<Preparation of Recording Sheet of Comparative 8>>

The recording sheet was prepared in the same manner as in the present invention 9 except for changing the ink-receptive layer coating solution to the following composition. Provided that a timing of coating the coating solution containing a cross-linking agent was delayed. That is, after coating and cooling an ink-receptive layer coating solution, the support was dried at the time at which a concentration of solid components of an ink-receptive layer became 35%, and a coating solution containing a cross-linking agent was coated. Incidentally, the condition of the above-mentioned concentration of solid components of 35% was a constant-drying-rate period.

<Ink-Receptive Layer Coating Solution>

| | |
|---|---|
| Silica dispersion 1 (As a silica solid component) | 100 parts |
| Acetoacetyl-modified polyvinyl alcohol (Acetoacetylation | 23 parts |
| degree: 3%, Saponification degree: 98%, Average | |
| polymerization degree: 2350) | |
| Basic polyaluminum hydroxide | 3 parts |

<<Preparation of recording sheet of Comparative 9>>

The recording sheet was prepared in the same manner as in the present invention 9 except for changing the ink-receptive layer coating solution to the following composition.

<Ink-Receptive Layer Coating Solution>

| | |
|---|---|
| Silica dispersion 1 (As a silica solid component) | 100 parts |
| Polyvinyl alcohol (Saponification degree: 88%, Average | 23 parts |
| polymerization degree: 3500) | |
| Boric acid | 5 parts |
| Basic polyaluminum hydroxide | 3 parts |

With regard to the obtained respective ink-jet recording sheets, evaluation was carried out in the same manner as in Example 1. The results are shown in Table 2. Incidentally, an average secondary particle size of the fine silca particles was each 80 nm.

TABLE 2

| | | | Ink | | | |
|---|---|---|---|---|---|---|
| | | | absorp- | | Crack | |
| | | | tion | Water | by | |
| Recording | | Gloss- | abili- | resis- | fold- | Coating |
| sheet | Cracks | iness | ty | tance | ing | defects |
| Present | ◯ | ◯ | ◯ | ◯ | ◯ | ◯ |
| invention 9 | | | | | | |
| Present | ◯ | ◯ | ◯ | ◯ | ◯ | ◯ |
| invention 10 | | | | | | |
| Comparative 8 | ◯ | ◯ | ◯ | ◯ | ◯ | X |
| Comparative 9 | X | X | ◯ | — | — | — |

The present invention causes neither cracks nor coating defects even when it is dried at 50° C. or higher, whereby drying efficiency is improved. Also, the present invention is excellent in glossiness, ink-absorption ability and water resistance, and causes no cracks by folding. Comparative 8 was a case where the coating solution containing a cross-linking agent was coated after coating the ink-receptive layer coating solution and during a constant ratio drying stage, and the viscosity of the ink-receptive layer was not sufficiently increased at the time of coating the later coating solution, so that coating defects such as coating unevenness, etc., occurred.

### EXAMPLE 4

Examples in which finely pulverized wet process silica was used as inorganic fine particles in place of the fumed silica are shown below.

<<Preparation of Recording Sheet of the Present Invention 11>>

A support was prepared by applying a high-frequency corona discharge treatment onto the surface of the polyolefin resin-coated paper of the present invention 1 in Example 1, and then a primer layer having the following composition was coated and dried so that the coated amount of gelatin became 50 mg/m² (about 0.05 μm).

<Primer Layer>

| | |
|---|---|
| Lime-treated gelatin | 100 parts |
| 2-Ethylhexyl sulfosuccinate | 2 parts |
| Chromium alum | 10 parts |
| Adipic acid dihydrazide (cross-linking agent) | 700 parts |

Onto the above-mentioned support was coated the ink-receptive layer coating solution having the following composition so that the coated amount of the silica fine particle was 22 g/m² according to the slide bead system. The drying conditions were the same as in the present invention 1 in Example 1.

<Preparation of Silica Dispersion 3>

To water were added 4 parts of dimethyldiallyl ammonium chloride homopolymer (Molecular weight: 9,000) and 100 parts of precipitation method silica (Oil absorption amount of 200 ml/100 g, Average primary particle size of 16 nm, Average agglomerated particle size of 9 μm), whereby a provisional dispersion was prepared by using a saw blade type dispersing device (blade peripheral speed: 30 m/sec). Next, the obtained provisional dispersion was treated with beads mill to give Silica dispersion 3 with the concentration of solid components of 30%.

<Ink-Receptive Layer Coating Solution>

| | | |
|---|---|---|
| Silica dispersion 3 (As a silica solid component) | 100 | parts |
| Acetoacetyl-modified polyvinyl alcohol (Acetoacetylation | 16 | parts |
| degree: 3%, Saponification degree: 98%, Average | | |
| polymerization degree: 2350) | | |
| Basic polyaluminum hydroxide | 3 | parts |
| Nonionic surfactant | 0.4 | part |

(Polyoxyethylene Alkyl Ether)

Silica dispersion 3 and other chemicals dissolved in water were mixed at 40° C. to prepare an ink-receptive layer coating solution having a concentration of solid components of 20%.

<<Preparation of Recording Sheet of the Present Invention 12>>

The primer layer of the support of the present invention 11 was changed to the same primer layer composition used for preparation of the recording sheet of Comparative 1.

Onto the above-mentioned support, a coating solution containing a cross-linking agent having the following composition was firstly coated so that the coated amount of adipic acid dihydrazide became 0.35 g/m² by a coating system using a fountain bar and air knife, and before drying the layer, an ink-receptive layer coating solution of the present invention 11 was coated by a slide curtain system. Other conditions were the same as those of the present invention 11.

<Coating Solution Containing Cross-Linking Agent>

| | | |
|---|---|---|
| Adipic acid dihydrazide | 100 | parts |
| Betaine surfactant | 0.1 | part |

The concentration of the solid component was adjusted to be 3% with water.
<<Preparation of Recording Sheet of the Present Invention 13>>

A support was prepared in the same manner as in the present invention 12. Onto said support was so coated an ink-receptive layer coating solution having the following composition that the coated amount of the fine silica particles became 22 g/m² according to the slide-bead system, and the coated layer was firstly cooled to 0° C. for 15 seconds to thicken the coated solution, and then, a coating solution containing a cross-linking agent and having the following composition was so coated that the coated amount of the adipic acid dihydrazide became 0.35 g/m² according to the direct fountain system. Then, the material was heated at 80° C. for 15 seconds, and further dried by blowing air at 50° C. and 70° C. successively.

<Ink-Receptive Layer Coating Solution>

| | | |
|---|---|---|
| Silica dispersion 3 (As a silica solid component) | 100 | parts |
| Acetoacetyl-modified polyvinyl alcohol | 16 | parts |

(Acetoacetylation degree: 3%, Saponification degree: 98%, Average polymerization degree: 2350)

| | | |
|---|---|---|
| Boric acid | 0.6 | part |
| Basic polyaluminum hydroxide | 3 | parts |

<Coating Solution Containing Cross-Linking Agent>

| | | |
|---|---|---|
| Adipic acid dihydrazide (cross-linking agent) | 100 | parts |
| Nonionic surfactant (Polyoxyethylene alkyl ether) | 0.1 | part |

The concentration of the solid component was adjusted to be 3% with water.
<<Preparation of Recording Sheet of the Present Invention 14>>

The recording sheet was prepared in the same manner as in the present invention 13 except for changing the coated amount of the adipic acid dihydrazide to 0.07 g/m².

<<Preparation of Recording Sheet of Comparative 10>>

The recording sheet was prepared in the same manner as in the present invention 11 except for changing the primer layer to the same primer layer composition used in Preparation of recording sheet of Comparative 1.

<<Preparation of Recording Sheet of Comparative 11>>

The recording sheet was prepared in the same manner as in the present invention 11 except for changing the ink-receptive layer coating solution to the following composition.

<Ink-Receptive Layer Coating Solution>

| | |
|---|---|
| Silica dispersion 3 (As the silica solid component) | 100 parts |
| Polyvinyl alcohol (Saponification degree: 88%, Average | 16 parts |
| polymerization degree: 3500) | |
| Boric acid | 2 parts |
| Basic polyaluminum hydroxide | 3 parts |

<<Preparation of Recording Sheet of Comparative 12>>

The recording sheet was prepared in the same manner as in the present invention 11 except for using the primer layer of Comparative 10 and the ink-receptive layer coating solution of Comparative 11.

<<Preparation of Recording Sheet of Comparative 13>>

A support was prepared in the same manner as in the present invention 12. Onto said support was so coated an ink-receptive layer coating solution having the following composition that a coated amount of the silica fine particle became 22 g/m² according to the slide bead system. After drying the same until a concentration of solid components of said ink-receptive layer coating solution became 40%, a coating solution containing a cross-linking agent having the following composition was so coated that the coated amount of adipic acid dihydrazide became 0.35 g/m² according to the direct fountain system. Then, the material was heated at 80° C. for 15 seconds, and further dried by blowing air at 50° C. and 70° C. successively. Incidentally, the condition of the above-mentioned concentration of solid components of 40% was a constant-drying-rate period.

<Ink-Receptive Layer Coating Solution>

| | |
|---|---|
| Silica dispersion 3 (As the silica solid component) | 100 parts |
| Acetoacetyl-modified polyvinyl alcohol (Acetoacetylation | 16 parts |
| degree: 3%, Saponification degree: 98%, Average | |
| polymerization degree: 2350) | |
| Basic polyaluminum hydroxide | 3 parts |

<Coating Solution Containing Cross-Linking Agent>

| | | |
|---|---|---|
| Adipic acid dihydrazide (cross-linking agent) | 100 | parts |
| Nonionic surfactant (Polyoxyethylene alkyl ether) | 0.1 | part |

The concentration of the solid component was adjusted to be 3% with water.
<<Preparation of Recording Sheet of Comparative 14>>

The recording sheet was prepared in accordance with the present invention 13. Provided that the ink-receptive layer coating solution was changed to the ink-receptive, layer coating solution of Comparative 11.

<<Preparation of Recording Sheet Comparative 15>>

The recording sheet was prepared in accordance with the present invention 12. It was prepared in the same manner as in the present invention 11 except for coating an ink-receptive layer coating solution having the following composition onto said support.

<Ink-Receptive Layer Coating Solution>

| | | |
|---|---|---|
| Silica dispersion 3 (As a silica solid component) | 100 | parts |
| Acetoacetyl-modified polyvinyl alcohol (Acetoacetylation | 16 | parts |
| degree: 3%, Saponification degree: 98%, Average | | |
| polymerization degree: 2350) | | |
| Basic polyaluminum hydroxide | 3 | parts |
| Adipic acid dihydrazide (cross-linking agent) | 1.6 | parts |

With regard to the obtained respective ink-jet recording sheets, evaluation was carried out in the same manner as in Example 1. The results are shown in Table 3. Incidentally, the average secondary particle size of the fine silica particles was each 100 nm.

TABLE 3

| | | | Ink | | | |
|---|---|---|---|---|---|---|
| | | | absorp- | | Crack | |
| | | | tion | Water | by | |
| Recording | | Gloss- | abili- | resis- | fold- | Coating |
| sheet | Cracks | iness | ty | tance | ing | defects |
| Present | ◯ | ◯ | ◯ | ◯ | ◯ | ◯ |
| invention 11 | | | | | | |
| Present | ◯ | ◯ | ◯ | ◯ | ◯ | ◯ |
| invention 12 | | | | | | |
| Present | ◯ | ◯ | ◯ | ◯ | ◯ | ◯ |
| invention 13 | | | | | | |
| Present | ◯ | ◯ | ◯ | ◯ | ◯ | ◯ |
| invention 14 | | | | | | |
| Comparative 10 | X | X | X | — | — | — |
| Comparative 11 | X | X | ◯ | — | — | — |
| Comparative 12 | X | X | ◯ | — | — | — |
| Comparative 13 | ◯ | ◯ | ◯ | ◯ | ◯ | X |
| Comparative 14 | X | X | ◯ | — | — | — |
| Comparative 15 | ◯ | ◯ | ◯ | ◯ | ◯ | X |

The present invention causes neither cracks nor coating defects even when it is dried at 50° C. or higher, whereby drying efficiency is improved. Also, the present invention is excellent in glossiness, ink-absorption ability and water resistance, and causes no cracks by folding.

### EXAMPLE 5

Examples in which alumina hydrate was used as inorganic fine particles in place of fine silica particles are shown below.

<<Preparation of Recording Sheet of the Present Invention 15>>

A support was prepared by applying a high-frequency corona discharge treatment onto the surface of the polyolefin resin-coated paper of the present invention 1 in Example 1, and then a primer layer having the following composition was coated and dried so that the coated amount of gelatin became 50 mg/m² (about 0.05 μm).

<Primer Layer>

| | |
|---|---|
| Lime-treated gelatin | 100 parts |
| 2-Ethylhexyl sulfosuccinate | 2 parts |
| Chromium alum | 10 parts |
| Adipic acid dihydrazide (cross-linking agent) | 960 parts |

Onto the above-mentioned support was so coated an ink-receptive layer coating solution having the following composition that the coated amount of the fine alumina hydrate particles became 40 g/m² according to the slide bead system. The drying conditions were the same as those of the present invention 1 in Example 1.

<Preparation of Dispersion of Alumina Hydrate>

To water were added nitric acid (2 parts) and pseudoboehmite (average primary particle size of 14 nm), and by using a saw blade type dispersing device, an alumina hydrate dispersion having a concentration of solid components of 30% was prepared.

<Ink-Receptive Layer Coating Solution>

| | |
|---|---|
| Alumina hydrate dispersion (As the alumina hydrate solid | 100 parts |
| component) | |
| Acetoacetyl-modified polyvinyl alcohol (Acetoacetylation | 12 parts |
| degree: 3%, Saponification degree: 98%, Average | |
| polymerization degree: 2350) | |
| Basic polyaluminum hydroxide | 2 parts |

Alumina hydrate dispersion and other chemicals dissolved in water were mixed at 40° C. to prepare a coating solution for an ink-receptive layer having the concentration of solid components of 22%.

<<Preparation of Recording Sheet of the Present Invention 16>>

The primer layer of the support in the present invention 15 was changed to the primer layer having the same composition as the primer layer used in Preparation of recording sheet of Comparative 1.

Onto the above-mentioned support, a coating solution containing a cross-linking agent having the following composition was firstly coated so that the coated amount of the adipic acid dihydrazide became 0.48 g/m² by the coating system using a fountain bar and air knife, and before drying the coated solution, an ink-receptive layer coating solution of the present invention 15 was coated by a slide curtain system. Other conditions were the same as in the present invention 15.

<Coating Solution Containing Cross-Linking Agent>

| | | |
|---|---|---|
| Adipic acid dihydrazide (cross-linking agent) | 100 | parts |
| Betaine surfactant | 0.1 | part |

The concentration of the solid component was adjusted to be 3% with water.
<<Preparation of Recording Sheet of the Present Invention 17>>

A support was prepared in the same manner as in the present invention 16. Onto said support, an ink-receptive layer coating solution having the following composition was coated so that the coated amount of the fine alumina hydrate particles became 40 g/m² by the slide bead system, and after cooling to 0° C. for 15 seconds to thicken the coated solution, then, a coating solution containing a cross-linking agent and having the following composition was coated so that the coated amount of the adipic acid dihydrazide became 0.48 g/m² by the direct fountain system. Then, the material was heated at 80° C. for 15 seconds, and then, dried by blowing air at 50° C. and 70° C. successively.

<Ink-Receptive Layer Coating Solution>

| | | |
|---|---|---|
| Alumina hydrate dispersion (As the alumina hydrate solid | 100 | parts |
| component) | | |
| Acetoacetyl-modified polyvinyl alcohol (Acetoacetylation | 12 | parts |
| degree: 3%, Saponification degree: 98%, Average | | |
| polymerization degree: 2350) | | |
| Boric acid | 0.4 | part |
| Basic polyaluminum hydroxide | 2 | parts |

<Coating Solution Containing Cross-Linking Agent>

| | | |
|---|---|---|
| Adipic acid dihydrazide (cross-linking agent) | 100 | parts |
| Nonionic surfactant (Polyoxyethylene alkyl ether) | 0.1 | part |

The concentration of the solid component was adjusted to be 3% with water.
<<Preparation of Recording Sheet of the Present Invention 18>>

The recording sheet was prepared in the same manner as in the present invention 17 except for changing the coated amount of the adipic acid dihydrazide to 0.1 g/m².

<<Preparation of Recording Sheet of Comparative 16>>

The recording sheet was prepared in the same manner as in the present invention 15 except for changing the primer layer to the primer layer having the same composition used in Preparation of recording sheet of Comparative 1.

<<Preparation of Recording Sheet of Comparative 17>>

The recording sheet was prepared in the same manner as in the present invention 15 except for changing the ink-receptive layer coating solution to that having the following composition.

<Ink-Receptive Layer Coating Solution>

| | | |
|---|---|---|
| Alumina hydrate dispersion (As the alumina hydrate solid | 100 | parts |
| component) | | |
| Polyvinyl alcohol (Saponification degree: 88%, Average | 12 | parts |
| polymerization degree: 3500) | | |
| Boric acid | 0.4 | part |
| Basic polyaluminum hydroxide | 2 | parts |

<<Preparation of Recording Sheet of Comparative 18>>

The recording sheet was prepared in the same manner as in the present invention 15 except for using the primer layer of Comparative 16 and the ink-receptive layer coating solution of Comparative 17.

<<Preparation of Recording Sheet of Comparative 19>>

The support was prepared in the same manner as in the present invention 16. Onto said support, an ink-receptive layer coating solution having the following composition was coated so that the coated amount of the fine alumina hydrate particles became 40 g/m² by the slide bead system. Drying was carried out until the concentration of solid components of said ink-receptive layer coating solution became 40%, and then, a coating solution containing a cross-linking agent having the following composition was coated so that the coated amount of the adipic acid dihydrazide became 0.48 g/m² by the direct fountain system. Then, the material was heated at 80° C. for 15 seconds, and then, dried by blowing air at 50° C. and 70° C. successively. The condition of the above-mentioned concentration of solid components of 40% was a constant-drying-rate period.

<Ink-Receptive Layer Coating Solution>

| | | |
|---|---|---|
| Alumina hydrate dispersion (As the alumina hydrate solid | 100 | parts |
| component) | | |
| Acetoacetyl-modified polyvinyl alcohol (Acetoacetylation | 12 | parts |
| degree: 3%, Saponification degree: 98%, Average | | |
| polymerization degree: 2350) | | |
| Basic polyaluminum hydroxide | 2 | parts |

<Coating Solution Containing Cross-Linking Agent>

| | | |
|---|---|---|
| Adipic acid dihydrazide (cross-linking agent) | 100 | parts |
| Nonionic surfactant (Polyoxyethylene alkyl ether) | 0.1 | part |

The mixture was adjusted with water to have the concentration of solid components of 3%.
<<Preparation of Recording Sheet of Comparative 20>>

The recording sheet was prepared according to the present invention 17. Provided that the ink-receptive layer coating solution was changed to the ink-receptive layer coating solution of Comparative 17.

<<Preparation of Recording Sheet of Comparative 21>>

The support was prepared in the same manner as in the present invention 16. The recording sheet was prepared in the same manner as in the present invention 15 except for coating an ink-receptive layer coating solution having the following composition onto said support.

<Ink-Receptive Layer Coating Solution>

| | | |
|---|---|---|
| Alumina hydrate dispersion (As the alumina hydrate solid | 100 | parts |
| component) | | |
| Acetoacetyl-modified polyvinyl alcohol (Acetoacetylation | 12 | parts |
| degree: 3%, Saponification degree: 98%, Average | | |
| polymerization degree: 2350) | | |
| Basic polyaluminum hydroxide | 2 | parts |
| Adipic acid dihydrazide (cross-linking agent) | 1.2 | parts |

With regard to the obtained respective ink-jet recording sheets, the same evaluations as in Example 1 were carried out. The results are shown in Table 4.

TABLE 4

| | | | Ink | | | |
|---|---|---|---|---|---|---|
| | | | absorp- | | Crack | |
| | | | tion | Water | by | |
| Recording | | Gloss- | abili- | resis- | fold- | Ccating |
| sheet | Cracks | iness | ty | tance | ing | defects |
| Present | ◯ | ◯ | ◯ | ◯ | ◯ | ◯ |
| invention 15 | | | | | | |
| Present | ◯ | ◯ | ◯ | ◯ | ◯ | ◯ |
| invention 16 | | | | | | |
| Present | ◯ | ◯ | ◯ | ◯ | ◯ | ◯ |
| invention 17 | | | | | | |
| Present | ◯ | ◯ | ◯ | ◯ | ◯ | ◯ |
| invention 18 | | | | | | |
| Comparative 16 | X | X | X | — | — | — |
| Comparative 17 | X | X | ◯ | — | — | — |
| Comparative 18 | X | X | ◯ | — | — | — |
| Comparative 19 | ◯ | ◯ | ◯ | ◯ | ◯ | X |
| Comparative 20 | X | X | ◯ | — | — | — |
| Comparative 21 | ◯ | ◯ | ◯ | ◯ | ◯ | X |

The present invention causes neither cracks nor coating defects even when it is dried at 50° C. or higher, whereby drying efficiency is improved. Also, the present invention is excellent in glossiness, ink-absorption ability and water resistance, and causes no cracks by folding.

### EXAMPLE 6

Examples in which a cast-coated paper which was a water-absorptive support was used as a support are shown below.

<<Preparation of Recording Sheet of the Present Invention 19>>

<Preparation of Cast-Coated Paper>

In water were dispersed 50 parts of kaolin, 50 parts of calcium carbonate, and 0.5 part of sodium polyacrylate to prepare a pigment slurry with the concentration of solid components of 65%. To the slurry were added 0.5 part of tributyl phosphate (defoaming agent), 1.0 part of ammonium stearate (releasing agent), 5 parts in a solid content of 15% casein aqueous solution, and 18 parts in a solid content of a styrene-butadiene copolymer latex to prepare a coating solution of a cast coat layer with a concentration of solid components of 45%. This coating solution was coated on a base paper with a basis weight of 150 g/m² by an air knife coater so that the dry coated amount became 20 g/m², then, the material was contacted with a cast drum with a surface temperature of 105° C. to dry the coated solution whereby a cast-coated paper was prepared.

Onto the cast-coated paper, a coating solution containing a cross-linking agent having the following composition and an ink-receptive layer coating solution of the present invention 15 in Example 5 were coated by the tandem system. After coating the coating solution containing a cross-linking agent, and before drying said coating solution, the ink-receptive layer coating solution was coated and heated at 120° C. for 15 seconds to gel the coated solution, and then, dried by blowing air at 100° C.

The coated amount of the adipic acid dihydrazide was 0.3 g/m², and the coated amount of the alumina-hydrate was 30 g/m².

<Coating Solution Containing Cross-Linking Agent>

| | |
|---|---|
| Adipic acid dihydrazide (cross-linking agent) | 100 parts |
| Polyvinyl alcohol | 100 parts |

| | |
|---|---|
| Adipic acid dihydrazide (cross-linking agent) | 100 parts |
| Acetoacetyl-modified polyvinyl alcohol | 100 parts |

(Saponification degree: 80%, Average polymerization degree: 500)

The mixture was adjusted with water to have the concentration of solid components of 5%. <<Preparation of Recording Sheet of the Present Invention 20>>

The recording sheet was prepared according to the present invention 19. Provided that the coating solution containing a cross-linking agent was coated, and after drying the solution, then, an ink-receptive layer was provided.

<<Preparation of Recording Sheet of the Present Invention 21>>

The recording sheet was prepared in the same manner as in the present invention 19 except for changing the coating solution containing a cross-linking agent to the coating solution having the following composition.

<Coating Solution Containing Cross-Linking Agent>

(Acetoacetylation degree: 3%, Saponification degree: 98%, Average polymerization degree: 2350)

The mixture was adjusted with water to have the concentration of solid components of 2%.

<<Preparation of Recording Sheet of the Present Invention 22>>

The recording sheet was prepared according to the present invention 21. Provided that a coating solution containing a cross-linking agent was coated and dried, and then an ink-receptive layer was coated.

<<Preparation of Recording Sheet of the Present Invention 23>>

The recording sheet was prepared in the same manner as in the present invention 19 except for changing the coating solution containing the cross-linking agent to a coating solution with the following composition. The coated amount of the zirconium salt was 0.3 g/m².

<Coating Solution Containing Cross-Linking Agent>

| | |
|---|---|
| Ammonium zirconium carbonate (cross-linking agent) | 100 parts |
| Acetoacetyl-modified polyvinyl alcohol | 100 parts |

(Acetoacetylation degree: 3%, Saponification degree: 98%, Average polymerization degree: 2350)

The mixture was adjusted with water to have the concentration of solid components of 2%.

<<Preparation of Recording Sheet of Comparative 22>>

The recording sheet was prepared in the same manner as in the present invention 19 except for coating a coating solution containing a cross-linking agent.

With respect to the respective ink-jet recording sheets, when the same evaluations were carried out as in Example 1, recording sheets of the present invention were all excellent in characteristics. On the other hand, Comparative 22 caused cracks remarkably and could not be practically used.

1. A process for preparing an ink-jet recording material which comprises an ink-receptive layer (A) containing fine inorganic particles having an average secondary particle size of 500 nm or less and a resin binder having a keto group on a support, wherein a coating solution (B) containing a cross-linking agent of the resin binder having a keto group is previously coated onto the above support, and then a coating solution of the above-mentioned ink-receptive layer (A) is coated on the coating solution (B).

2. The process for preparing ink-jet recording material according to claim 1, wherein the resin binder having a keto group is a modified polyvinyl alcohol having a keto group.

3. The process for preparing ink-jet recording material according to claim 1, wherein the resin binder having a keto group is an acetoacetyl-modified polyvinyl alcohol or a diacetoneacrylamide-modified polyvinyl alcohol.

4. The process for preparing ink-jet recording material according to claim 1, wherein the cross-linking agent is a compound having two or more primary amino groups in the molecule or a polyvalent metal salt.

5. The process for preparing ink-jet recording material according to claim 4, wherein the compound having two or more primary amino groups in the molecule is a compound having two or more hydrazide groups in the molecule.

6. The process for preparing ink-jet recording material according to claim 1, wherein the support is polyolefin resin-coated paper.

7. The process for preparing ink-jet recording material according to claim 1, wherein the support is cast-coated paper.

8. A process for preparing ink-jet recording material which comprises an ink-receptive layer (A) containing fine inorganic particles having an average secondary particle size of 500 nm or less and a resin binder having a keto group on a support, wherein a coating solution containing a boron compound in addition to the coating solution of the above-mentioned ink-receptive layer (A) on the above-mentioned support, and then a the coating solution (B) containing a cross-linking agent of the resin binder containing the above keto group is coated on a coated film of the above-mentioned coating solution.

9. The process for preparing ink-jet recording material according to claim 8, wherein the resin binder having a keto group is a modified polyvinyl alcohol having a keto group.

10. The process for preparing ink-jet recording material according to claim 8, wherein the resin binder having a keto group is an acetoacetyl-modified polyvinyl alcohol or a diacetoneacrylamide-modified polyvinyl alcohol.

11. The process for preparing ink-jet recording material according claim 8, wherein the cross-linking agent is a compound having two or more primary amino groups in the molecule or a polyvalent metal salt.

12. The process for preparing ink-jet recording material according to claim 11, wherein the compound having two or more primary amino groups in the molecule is a compound having two or more hydrazide groups in the molecule.

13. The process for preparing ink-jet recording material according claim 8, wherein the boron compound is at least one compound selected from boric acid, a borate and borax.

14. The process for preparing ink-jet recording material according to claim 8, wherein the support is polyolefin resin-coated paper.

15. The process for preparing ink-jet recording material according to claim 8, wherein the support is cast-coated paper.
